(19) United States
(12) Patent Application Publication
(10) Pub. No.: US 2010/0316447 A1
(43) Pub. Date: Dec. 16, 2010

(54) INORGANIC-ORGANIC BINDER, METHOD FOR THE PRODUCTION THEREOF, AND USE THEREOF

(75) Inventors: Christian Schmidt, Saarbruecken (DE); Helmut Schmidt, Saarbruecken-Guedingen (DE)

Correspondence Address: GREENBLUM & BERNSTEIN, P.L.C., 1950 ROLAND CLARKE PLACE, RESTON, VA, 20191, US

(73) Assignee: EPG (ENGINEERED NANOPRODUCTS GERMANY) AG, Zweibruecken (DE)

(21) Appl. No.: 12/746,820

(22) PCT Filed: Dec. 9, 2008
(86) PCT No.: PCT/EP08/67094

§ 371 Date: Sep. 1, 2010

(30) Foreign Application Priority Data
Dec. 10, 2007 (DE) 10 2007 059 423.4

(51) Int. Cl. C09K 8/56; C04B 14/02; C04B 16/04; E02D 3/02; B09C 1/08

(52) U.S. Cl. 405/128.75; 106/491; 523/130; 523/131; 405/271

(57) ABSTRACT

A process for the preparation of a binder comprising a heterocondensate of (i) a hydrolysable silicon compound having at least one nonhydrolysable organic radical without polymerizable group and (ii) a metal and/or boron compound. The process comprises hydrolyzing (i) with water, adding (ii) to the resultant reaction mixture after the water in the reaction mixture is substantially consumed, and, optionally, adding an organic binder component to the heterocondensate and/or a precursor thereof.

The invention relates to a process for the preparation of a binder, the binder obtainable therefrom, the use thereof and the hardened moldings produced therewith.

Binders are materials which as a rule are applied in viscous or liquid form to surfaces, introduced or mixed into finely divided, pulverulent or granular materials, and which are converted from their viscous or liquid form into a solid form via a generally chemical process. They thereby bind the substrates firmly to each other.

Depending on the behaviour of these binders, voids as occur, for example, in particulate materials and beds may be completely filled or merely remain completely or partly open. If they are intended to remain completely or partly open, then the binder must undergo a pronounced volume contraction during hardening, and the remaining binder volume must contract as far as possible to the contact points of the particles. Such behaviour is also referred to as a syneresis effect and occurs in particular in the case of inorganic gels with the use of the sol-gel process. Depending on the formulation and behaviour of the binder, either sealing of a bed is obtained or the bound particles remain porous.

Typical examples of inorganic binders are cements, gypsum or lime. Typical examples of organic or polymer binders are organic adhesives, bitumen, glue or similar materials.

The method of hardening the binder may be very different: inorganic binders can as a rule harden with water (hydraulic binders); this may also be associated with a hydrothermal process. Sometimes a simple drying process is sufficient for hardening, for example if a binder is suspended in an organic solvent or in water. Other mechanisms may also be used, such as, for example, free radical crosslinking (this can be initiated by light or thermally), polyaddition or polycondensation. In the case of certain inorganic binders, in particular those in which sol-gel processes play a role, inorganic polycondensation processes may also be used, such as, for example, crosslinking of SiOH groups.

It is also possible to use binders in which various mechanisms are used, such as, for example, condensation in a sol-gel process in combination with an organic crosslinking reaction, such as, for example, free radical polymerization. Such binders and processes have already been described. Thus, for example, WO 2007/121972 and WO 2007/121975 describe inorganic-organic binders which are obtained from condensates of orthosilicic acid esters, alkoxysilanes, functionalized silanes which carry polymerizable groups and metal or boron compounds and polymerizable organic compounds, in particular monomers. Characteristic of these binders is that a covalent linkage between the inorganic moiety and the organic moiety of the binder occurs via the nonhydrolysable polymerizable group on the functionalized silane.

The disadvantage of the chemical structure resulting from this approach is that the linkage of the three-dimensionally crosslinking inorganic building block (the silane carrying polymerizable groups) results as a rule in very inflexible products which tend to become brittle and the mechanical strength of which is limited thereby. For avoiding such embrittlement, it is therefore necessary for the proportion of the organic component in the binder to be relatively high. Moreover, inhibition of the inorganic polycondensation may also occur in the case of such a structure, which in turn adversely affects the chemical resistance or the ecological stability, in particular at high pressures and temperatures.

The object of the present invention therefore consists in the development of a system which no longer has the abovementioned structural disadvantages. It was surprisingly found that efficient binders of the type consisting of an inorganic-organic interpenetrating network (IPN=interpenetrating networks, cf., for example, Römpp Chemie Lexikon [Römpp Chemistry Lexikon], 9th edition, page 2007) can be prepared even without linkage of the inorganic constituent to the organic component via a chemical bond.

The invention therefore provides a process for the preparation of a binder comprising a) a heterocondensate of at least one hydrolysable silicon compound having at least one nonhydrolysable organic radical and at least one metal or boron compound, the metal being selected from Al, Ga, In, Tl, Ge, Sn, Pb, Ti, Zr, Hf, Sc, Y and La, and optionally b) at least one organic binder component, in which
A) the silicon compound is mixed with water for hydrolysis and
B) the metal or boron compound is added to the resulting reaction mixture when the added water in the reaction mixture has been substantially consumed, and optionally
C) the organic binder component is added to the resulting heterocondensate or a precursor thereof,
   the nonhydrolysable organic radical or radicals of the hydrolysable silicon compounds used having no polymerizable group.

The process according to the invention surprisingly makes it possible to obtain binders which have improved flexibility and less brittleness compared with binders according to the prior art described above which have a corresponding proportion of organic component.

A further advantage of the process according to the invention is that all components of the binder, independently of one another, can be at least partly reacted beforehand. Thus, the organic constituents can be prepared, for example, in the form of monomers, oligomers or optionally, if the polymer is sufficiently soluble in a certain solvent, even in the form of polymers. The inorganic constituents can also be prepared separately, for example via the sol-gel process.

For the preparation of the metal- or boron-containing binder, at least one silicon compound and at least one metal- or boron-containing component, preferably a titanium-containing component, are used. In a preferred embodiment, an organic matrix former can also be added to the binder. In the process according to the invention, homogeneous metal- or boron-containing binders are surprisingly obtained, which binders, when used for the production of a molding, substantially improve the corrosion resistance of the molding obtained. In addition, in a further preferred embodiment, the compressive strength of the moldings formed with the binder can be improved by use of long-chain silicon compounds, such as, for example, poly(alkoxysilanes) or polyalkylsiloxanes having reactive terminal groups, the resilience of the molding resulting from the formation of a long-chain inorganic network.

In the process according to the invention, a heterocondensate of silicon compounds and metal or boron compounds is formed. At least one hydrolysable silicon compound having at least one nonhydrolysable organic radical is used as the Si component, the organic radical or radicals of the Si compounds used carrying no polymerizable groups. It is also possible to use two or more of these compounds together.

At least one hydrolysable silicon compound having at least one nonhydrolysable organic group which comprises no polymerizable radicals is, for example, a compound or an organosilane of the general formula (I)

RₙSiX₄₋ₙ (I)

in which the radicals R are identical or different and represent groups which cannot be hydrolytically cleaved, the radicals X are identical or different and represent hydrolytically cleavable groups or hydroxyl groups and n has the value 1, 2 or 3, preferably 1 or 2.

Suitable examples of hydrolytically cleavable or hydrolysable groups X are hydrogen, halogen (F, Cl, Br, or I, in particular Cl or Br), alkoxy (e.g. C₁₋₆-alkoxy, such as, for example, methoxy, ethoxy, n-propoxy, isopropoxy and n-butoxy, isobutoxy, sec-butoxy or tert-butoxy), aryloxy (preferably C₆₋₁₀-aryloxy, such as, for example, phenoxy), alkaryloxy, e.g. benzoyloxy, acyloxy (e.g. C₁₋₆-acyloxy, preferably C₁₋₄-acyloxy, such as, for example, acetoxy or propionyloxy) and alkylcarbonyl (e.g. C₂₋₇-alkylcarbonyl, such as acetyl). Also suitable are NH₂, amino which is mono- or disubstituted by alkyl, aryl and/or aralkyl, examples of the alkyl, aryl and/or aralkyl radicals being those stated below for R, amido, such as benzamido, or aldoxime or ketoxime groups. Two or three groups X may also be linked to one another, for example in the case of Si-polyol complexes with glycol, glycerol or pyrocatechol. Said groups may optionally contain substituents such as halogen, hydroxyl or alkoxy.

Preferred hydrolysable radicals X are halogen, alkoxy groups and acyloxy groups. Particularly preferred hydrolysable radicals are alkoxy groups, preferably C₁₋₄-alkoxy groups, in particular methoxy and ethoxy.

The radicals R which are not hydrolytically cleavable are, for example, alkyl, e.g. C₁₋₂₀-alkyl, in particular C₁₋₄-alkyl, such as methyl, ethyl, n-propyl, isopropyl, n-butyl, isobutyl, sec-butyl and tert-butyl, aryl, in particular C₆₋₁₀-aryl, such as phenyl and naphthyl, and corresponding aralkyl and alkaryl groups, such as tolyl and benzyl, and cyclic C₃₋₁₂-alkyl and C₃₋₁₂-alkenyl groups, such as cyclopropyl, cyclopentyl and cyclohexyl. The radicals R may have customary substituents, e.g. halogen, such as chlorine or fluorine, and alkoxy. The radical R has no polymerizable group. Preferred radicals R are alkyl groups having preferably 1 to 4 carbon atoms, in particular methyl and ethyl, and aryl radicals, such as phenyl.

Examples of specific organosilanes of the general formula (I) are compounds of the following formulae:

CH₃SiCl₃, CH₃Si(OC₂H₅)₃, C₂H₅SiCl₃, C₂H₅Si(OC₂H₅)₃, C₃H₇Si(OC₂H₅)₃, C₆H₅Si(OC₂H₅)₃, (C₂H₅O)₃Si—C₃H₆—Cl, (CH₃)₂SiCl₂, (CH₃)₂Si(OC₂H₅)₂, (CH₃)₂Si(OCH₃)₂, (CH₃)₂Si(OH)₂, (C₆H₅)₂SiCl₂, (C₆H₅)₂Si(OC₂H₅)₂, (i-C₃H₇)₃SiOH, n-C₆H₁₃CH₂CH₂Si(OC₂H₅)₃, n-C₈H₁₇CH₂CH₂Si(OC₂H₅)₃, CH₂OCH₂CH₂O(CH₂)₃—Si(OC₂H₅)₃.

Particularly preferred silanes of the formula (I) are alkylsilanes, in particular alkyltrialkoxysilanes, with methyltrimethoxysilane and in particular methyltriethoxysilane (MTEOS) being particularly preferred.

In an embodiment, at least one hydrolysable silane without nonhydrolysable organic groups may be added as a further Si component in addition to the (a) at least one silicon compound having at least one nonhydrolysable group. If such silanes without nonhydrolysable groups are used, they are preferably mixed together with the hydrolysable silicon compound for hydrolysis with water and together form the Si component. If such silanes without nonhydrolysable groups are used, they are also taken into account as an Si component, for example, with respect to the water added or the Si to metal or boron ratio to be established.

Examples of hydrolysable silanes without nonhydrolysable groups which can be used are silanes of the general formula (II): SiX₄, in which the radicals X have the above meaning, including the preferred meaning, for X in formula (I). Specific examples are Si(OCH₃)₄, Si(OC₂H₅)₄, Si(OC₃H₇)₄, SiCl₄, HSiCl₃, Si(OOCCH₃)₄. Among these hydrolysable silanes, tetraethoxysilane (TEOS) is particularly preferred.

Silanes and below-described polysiloxanes can be prepared by known methods; cf. W. Noll, “Chemie and Technologie der Silicone [Chemistry and Technology of the Silicones]”, Verlag Chemie GmbH, Weinheim/Bergstraβe (1968).

An additional compound, in particular a hydrolysable compound, of an element selected from main group III, main group IV, subgroup III and subgroup IV is used as a further component for the heterocondensate. Said elements are B and a metal from these groups, in particular Al, Ga, In, Tl, Ge, Sn, Pb, Ti, Zr, Hf, Sc, Y and La. The corrosion resistance and hydrolysis stability of the hardened binder are increased by this component. Hydrolysable compounds of titanium, aluminium, zirconium, tin and boron are particularly preferred, titanium compounds being most preferred. The compounds may be used individually or as a mixture of two or more of these elements.

The metal or boron compound may be a compound of the formula (III)

MXₐ (III)

in which M is B, Al, Ga, In, Tl, Ge, Sn, Pb, Ti, Zr, Hf, Sc, Y and La, X is as defined in formula (I), including the preferred examples, it being possible for two groups X to be replaced by an oxo group, and a corresponds to the valency of the element, it also being possible for a to be greater than the valency of M when complex ligands are used or to be less than the valency of M in the case of polydentate ligands. The valency of M is as a rule 2, 3 or 4. The compound of the formula (III) optionally also comprises a counter-ion. In addition to the substituents stated in formula (I), X may also be sulphate, nitrate, a complexing agent, such as, for example, a β-diketone, a saturated or unsaturated carboxylic acid or the salt thereof, an inorganic acid or a salt thereof and an aminoalcohol. The metal or boron compound is in particular a hydrolysable compound. Metal or boron alkoxides are preferably used.

In a preferred embodiment, metal or boron compounds which comprise complex ligands, or a combination of metal or boron compounds and a complex ligand, are used. Without wishing to be bound by a theory, it is assumed that, with the use of a combination of metal or boron compounds and a complex ligand, binding of the complex ligand to the metal or boron of the metal or boron compound used takes place in situ. Of course, a complexing agent which can form such a bond is chosen. Suitable combinations can readily be chosen by the person skilled in the art. The combination can be obtained, for example, by simple mixing of the two components.

In a particularly preferred embodiment, the complexing agent comprises a polymerizable radical. The binders obtained therewith surprisingly show increased compressive strength. The polymerizable organic group may be any customary group which is known to the person skilled in the art and can undergo polymerization with itself or with one or more other corresponding polymerizable groups. The polymerizable group should be capable of undergoing a polymerization reaction, particularly under the given conditions (temperature, any other corresponding groups present, catalyst, etc.), for example in the preparation or in particular the hardening. Here in the description, polymerization also includes very generally polycondensation and polyaddition in addition to free radical polymerization. The polymerizable group of the complexing agent is preferably reactive, if used, with the polymerizable group of an organic binder component used, so that it is assumed that bonding between organic and inorganic network by complexing the metal or boron compound with the complexing agent is achieved thereby.

Examples of the complexing agents, including those having a polymerizable group, are acetylacetonate, ethyl acetoacetate, vinyl acetoacetate, methacrylic acid, dialkyl dithiophosphate, dodecylbenzenesulphonic acid, vinylpyridine, vinylbenzenesulphonic acid, oleic acid, palmitic acid and particularly 2-(methacryloyloxy)ethyl acetoacetate.

Examples of polymerizable groups or radicals (thermally polymerizable groups being preferred) which the complexing agent and the organic binder component explained below may have are epoxide, such as, for example, glycidyl or glycidyloxy, hydroxyl, amino, monoalkylamino, dialkylamino, optionally substituted anilino, amido, carboxyl, alkenyl, acryloyl, acryloyloxy, methacryloyl, methacryloyloxy, mercapto, cyano, isocyanato, aldehyde, keto, alkylcarbonyl, acid anhydride and phosphoric acid.

Preferred polymerizable groups are acyl or acyloxy, methacryloyl or methacryloyloxy.

Preferred metal compounds are the alkoxides of Ti; Zr and Al, in particular Ti. Suitable metal or boron compounds, including those with complexing agents, are, for example, Ti(OC₂H₅)₄, Ti(O-n- or i-C₃H₇)₄, Ti(OC₄H₉)₄, TiCl₄, Ti(O-iC₃H₇)₂Cl₂, hexafluorotitanic acid, TiOSO₄, diisopropoxybis(ethylacetoacetato)titanate, poly(di-butyl titanate), tetrakis(diethylamino)titanium, titanium 2-ethylhexoxide, titanium bis(triethanolamine) diisopropoxide, titanium chloride triisopropoxide, Al(OC₂H₅)₃, Al(O-sec-C₄H₉)₃, AlCl(OH)₂, Al(NO₃)₃, Zr(OC₃H₇)₄, zirconium 2-ethylhexoxide, BCl₃, B(OCH₃)₃ and SnCl₄, Zr(OC₃H₇)₂(OOC(CH₃)═CH₂)₂, titanium acetylacetonate, titanium oxide bis(pentanedionate), Ti(OC₃H₇)₃(OOC(CH₃)═CH₂) and Ti(OC₂H₄)₃(allylacetoacetate). Among the metal compounds, Ti(O-iC₃H₇)₄, Ti(OC₄H₉)₄, titanium bis(triethanolamine) diisopropoxide and Ti(OC₃H₇)₃(OOC(CH₃)═CH₂) and further Ti compounds comprising complexing agents are particularly preferred. As stated, a combination of the metal or boron compound with the desired complexing agent can alternatively be used.

The molar ratio of Si atoms of all Si compounds used to the metal atoms and boron atoms of all abovementioned metal and boron compounds used can be chosen within wide ranges but is preferably 10:1 to 1:3 and more preferably 5:1 to 1:1.

Apart from said metal or boron compounds, additional metal compounds may be used. Examples of such metal compounds are compounds of other glass- or ceramic-forming metals, in particular compounds of at least one metal from main group V and/or subgroups II and V to VIII of the Periodic Table of the Elements. These are preferably hydrolysable compounds of Mn, Cr, Fe, Ni and in particular V or Zn. For example, hydrolysable compounds of elements of main groups I and II of the Periodic Table, e.g. Na, K, Ca and Mg, can also be used. It is also possible to use hydrolysable compounds of the lanthanides, such as Ce. These are metal compounds of the general formula M′Xₐ, in which M′ is a metal of main groups I, II or V or subgroups II and V to VIII of the Periodic Table of the Elements or a lanthanide and X and a are as defined in formula (III).

In a further particularly preferred embodiment, a purely organic component is also added, so that an additional organic matrix can be produced. By additional use of such an organic binder component, even further improved mechanical strength and flexibility can be achieved. This gives rise after curing to two interpenetrating polymers, namely the heterocondensate and a purely organic polymer, so that IPN polymers are formed, which were described generally above. The interpenetrating polymers may be purely physically mixed. Without wishing to be bound by a theory, a certain binding of heterocondensate and purely organic component via the use of complexing agent having a polymerizable group, explained above, can be achieved. In addition to the binding via complexing, binding via ionic interactions, dipolar interactions, hydrogen bonds or van der Waals interactions is also conceivable. If, for example, vinylpyridine is used as a monomer for the organic component, the pyridine nitrogen can permit binding via ionic binding with Si—OH groups of the inorganic component via acid/base reactions.

One or more organic monomers, oligomers or polymers which, in a preferred embodiment, have in each case one or more polymerizable groups, in particular thermally polymerizable groups, are used for the organic binder component. It is also possible to use a mixture of two or more monomers, oligomers or polymers. In an alternative embodiment, it is possible to use organic oligomers or polymers which have no polymerizable groups, i.e. unreactive oligomers or polymers. The respective advantages of the alternatives are described further below. Examples of polymerizable groups have already been mentioned above in the case of the complexing agents, with C═C double bonds, in particular acryloyl and methacryloyl groups, hydroxyl, amino, carboxyl or acid anhydride groups, epoxide and/or isocyanate groups being preferred. Further examples are acid chloride groups and nitrile, isonitrile and SH groups.

If the organic binder component comprises polymerizable groups, the presence of at least two polymerizable groups is preferred. The polymerizable groups serve for the polymerization or linkage of the organic component, it being possible for said groups to be a polymerizable group or corresponding polymerizable groups. It is preferably chosen so that it is reactive with the polymerizable group of the complexing agent, if used.

Organic monomers, oligomers or polymers as a binder component are very familiar to the person skilled in the art and he can readily select them in a suitable manner according to requirements. The organic component used may be a defined individual compound or a mixture of compounds having different degrees of polymerization.

Suitable polymers are, for example, polyisocyanates, melamine resins, polyester and epoxide resins. Mono-, di- or polyfunctional acrylates and methacrylates are preferably used as a binder component. Further examples of the organic binder component are diethylene glycol dimethacrylate (DEGMA), triethylene glycol methacrylate (TEGDMA), bisphenol A glycidyl methacrylate (BisGMA), bisphenol A diacrylate, butyl acrylate (BA), diurethane dimethacrylate, urethane dimethacrylate (UDMA), styrene, styrene derivatives, vinylpyridine, vinylbenzenesulphonic acid, Laromer® acrylates of BASF, Ebecryl®, pentaerythrityl triacrylate (PETIA), hexanediol diacrylate, trimethylolpropane triacrylate, trimethylolpropane trimethacrylate, neopentylglycol dimethacrylate, neopentylglycol diacrylate, epoxyacrylate resins, oligomeric methacrylates, such as LR 8862, LR 8907 from BASF, or oligomeric urethane acrylates, such as UA 19T from BASF, and oligomers or polymers of said monomers.

It was found that a further improvement can be achieved if polysiloxanes, such as, for example, poly(alkoxysilanes) or polyalkylsiloxanes or corresponding polyarylsiloxanes and copolymers thereof are used as an additional component. It is possible to use polysiloxanes which carry no reactive groups. However, polysiloxanes which have at least one reactive group, in particular a reactive terminal group, are preferably used. IPN copolymers having covalent bonds between the interpenetrating polymers can be obtained thereby. However, IPN polymers which are purely physically mixed may also be formed.

There is a large variety of poly(alkoxysilanes), polyalkylsiloxanes and polyarylsilanes and copolymers thereof having reactive terminal groups. In particular, those polysiloxanes, in particular polyalkylsiloxanes, having reactive groups or terminal groups are commercially available, for example from Gelest, Inc., Philadelphia. Examples of the reactive group or terminal group are vinyl, hydride, silanol, alkoxy, amines, epoxy, carbinol, methacrylate/acrylate, mercapto, acetoxy, chloride and dimethylamine. Via the reactive groups or terminal groups, the polysiloxanes can be incorporated into the inorganic network or optionally into the organic matrix or crosslinked. If, for example, polysiloxanes having terminal silanol groups are used, the silanol group will react with hydroxyl groups of the hydrolysed silanes or of the metal or boron compounds. As a result, the resilience or compressive strength of the molding is surprisingly further increased.

The polysiloxanes may be cyclic, branched or preferably linear. The reactive group may be present on the main chain or a side chain but is preferably a terminal group. It is of course possible for more than one reactive group to be present, for example two or more reactive groups. A linear polysiloxane contains, for example, preferably 2 reactive terminal groups. Polysiloxanes having silanol and alkoxy groups, in particular polysiloxanes having terminal silanol groups, are preferably used as polysiloxanes having reactive groups or terminal groups.

Examples of poly(alkoxysilanes), polyalkylsiloxanes or polyarylsiloxanes and copolymers thereof are polydimethylsiloxanes, polydiethylsiloxanes, polymethyl-ethylsiloxanes, polydiphenylsiloxanes and corresponding copolymers which in each case contain at least one reactive group. Specific examples are polydimethylsiloxanes having terminal silanol groups or having terminal alkoxy groups, poly(diethoxysiloxanes) and polydimethoxysiloxanes.

The molecular weight of the polysiloxanes used can be chosen from a wide range, depending on the field of use, for example in the range from 100 to 10 000 g/mol. Preferred polysiloxanes are those having a molecular weight of 100 to 3500 g/mol and more preferably 300 to 3000 g/mol, e.g. 400 to 2000 g/mol.

It is also possible to use higher molecular weight polysiloxanes, for example having a molecular weight up to 50 000 g/mol or more. Here, the molecular weight is understood as meaning the number average molecular weight.

The reaction between polysiloxanes and silicon compounds or metal or boron compounds can take place in the presence of a catalyst, e.g. hexachloroplatinic acid, dibutyltin diacetate, or tin 2-ethylhexanoate, or at elevated temperature, e.g. 80° C., without it being necessary to hydrolyse the silicon compounds and/or metal or boron compounds beforehand.

The weight ratio of all inorganic components used, including the organic groups present therein, to the purely organic components, if used, can be chosen within wide ranges and is, for example, 95:5 to 5:95 and preferably 80:20 to 20:80, based on the hardened binder.

By the addition of the organic component, IPN polymers can be produced from interpenetrating polymers, namely the heterocondensate and the purely organic polymer.

As explained in detail below, heterocondensates are obtained as a soluble to viscous system from the hydrolysable silanes and the metal or boron compound by a two-stage process according to the invention by means of hydrolysis and partial condensation (precondensation), which system is then preferably mixed with the above-mentioned organic binder component with or without a solvent, the organic binder component preferably being added after maturing of the heterocondensate prepared.

If an organic binder component is used, it may be advantageous for achieving a sufficiently low-viscosity material if the organic fraction is used in the form of monomers or short-chain oligomers which in each case have at least one polymerizable group. These are then polymerized during the hardening. Inorganic fractions which have not yet undergone complete hydrolysis or polycondensation can be further reacted, for example during the hardening by diffusion of moisture, so that a stable inorganic network forms.

Another variant is the use of unreactive oligomers or polymers as the organic binder component. The advantage of such systems without a polymerizable group in the organic binder component is that shrinkage during polymerization no longer occurs. In combination with the hydrolysable silanes used, which carry a high proportion of nonpolymerizable organic groups, it is thus possible to prepare binders which show virtually no more shrinkage during the gel formation or solidification (hardening) and are therefore suitable in particular for sealing.

By using inorganic and organic components which carry both hydrophilic and hydrophobic groups (inert hydrocarbon groups=hydrophobic; SiOH groups=hydrophilic), so-called amphiphilic binders form which have good adhesion both to hydrophilic and to hydrophobic surfaces. The advantage of this property is that, for example, loose or porous substrates, such as beds, can be bound or filled independently of whether they have a hydrophilic or a hydrophobic surface.

The chemical stability of the systems is established via the type of organic components, in particular as a function of their polymerizable groups, but also by the suitable choice or synthesis of the inorganic constituent. Thus, it was found that composites which have, as the inorganic constituent, exclusively Si-containing components which are converted into corresponding silicate networks by hydrolysis and condensation very rapidly separate again under hydrothermal conditions.

This can be completely prevented according to the invention by the homogeneous incorporation of oxides of said metal or boron compounds, such as, for example, TiO₂ tetrahedra, into the silicate network. However, it has been found that this homogeneous incorporation is difficult to bring about. The attempt to incorporate, for example, titanium via the customary hydrolysis and condensation homogeneously or in molecular dispersion into hybrid structures cannot be realized in practice owing to the very different reaction rates of titanium alkoxides and organoalkoxysilanes. On addition of water, nanoparticulate, in some cases already crystalline, particles (TiO₂) form, which can be (also uniformly) distributed in the matrix but are not integrated in molecular or oligomeric form in the network.

For the preparation of a homogeneous heterocondensate, according to the invention first the hydrolysable silanes are therefore prehydrolysed by addition of water until virtually complete consumption of water, i.e. until the free water in the mixture is substantially consumed by conversion of SiOR into SiOH groups so that substantially no free water is any longer present. Immediate linkage of the metal or boron of the metal or boron compound to the SiOH group is achieved by subsequent addition of the rapidly reacting metal or boron compound, such as an alkoxide, e.g. a titanium alkoxide, aluminium alkoxide or zirconium alkoxide. No corresponding oxide of the metal or boron compound is precipitated and the network stabilization is achieved by formation of a homogeneous heterocondensate. After the end of this step, additional water can readily be added to the system without the heterooxides being precipitated.

In the process according to the invention, the hydrolysable silicon compound, optionally in combination with a silane without nonhydrolysable groups, is therefore first subjected to hydrolysis in the first stage by mixing with water. This is effected in particular by the sol-gel process. In the sol-gel process, the hydrolysable compounds are generally hydrolysed with water, optionally in the presence of acidic or basic catalysts. Preferably, the hydrolysis is effected in the presence of acidic catalysts, e.g. hydrochloric acid, phosphoric acid or formic acid, at a pH of preferably 1 to 3. Details of the sol-gel process are described, for example, by C. J. Brinker. G. W. Scherer: “Sol-Gel Science—The Physics and Chemistry of Sol-Gel Processing”, Academic Press, Boston, San Diego, New York, Sydney (1990).

For the hydrolysis, it is possible to use stoichiometric amounts of water, but also smaller or larger amounts, for example up to 1.2 mol of water per mole of the hydrolysable groups present. Preferably, a substoichiometric amount of water, based on the hydrolysable groups present, is used. The amount of water used for the hydrolysis and condensation of the hydrolysable compounds is preferably 0.1 to 0.9 mol and particularly preferably 0.25 to 0.75 mol of water per mole of the hydrolysable groups present. Often, particularly good results are obtained with less than 0.7 mol of water, in particular 0.45 to 0.65 mol of water, per mole of the hydrolysable groups present. Here, all hydrolysable groups of the starting compounds added altogether, i.e. including those of the metal or boron compounds added only later, are understood as meaning hydrolysable groups present.

The process according to the invention is a two-stage process, with the result that a very homogeneous heterocondensate having substantially improved properties can be obtained. In the mixture of hydrolysable silanes and water, hydrolysis of the silanes first takes place. As a result of the hydrolysis, the added free water is consumed. The hydrolysed silanes can then undergo condensation reactions in which water is liberated again. Even if condensation reactions can begin before the silanes have been completely hydrolysed, the content or the concentration of free water in the mixture decreases to a minimum after addition of the water as a function of time and then increases again owing to condensation reactions. Since preferably not more than a stoichiometric amount and preferably a substoichiometric amount, based on the hydrolysable groups of the hydrolysable silanes, of water is added, the water used is first completely or substantially completely consumed before water is liberated again by the condensation, i.e. at the minimum virtually no water or only a little water is present in the mixture.

According to the invention, the metal or boron compound is therefore added to the mixture of the hydrolysable silicon compound and water when the water in the reaction mixture has been substantially consumed by the hydrolysis, i.e. at the time of addition of the metal or boron compound no water or only a small amount of water, preferably less than 15%, more preferably less than 10% and particularly preferably less than 5% of the amount of water which was added to the hydrolysis, is present in the reaction mixture. The metal or boron compound is also added in particular before a higher content of free water forms again in the reaction mixture as a result of the condensation reactions.

Since the reactions taking place are equilibrium reactions and in some cases condensation reactions can also take place during the hydrolysis itself, small amounts of water may still be present when the added water in the reaction mixture has been consumed. What is important is that the addition of the metal or boron compound is effected when the content of water in the reaction mixture is minimal or is in the region of the minimum.

The person skilled in the art is familiar with the methods for determining the water content in a mixture. Examples of suitable methods are the Karl-Fischer titration or IR spectroscopy. The suitable time span for the addition of the metal or boron compound can also be determined empirically in a simple manner, for example in the course of preliminary experiments in which the metal or boron compound is added to the mixture of hydrolysable silicon compound/water at certain times and a check is then carried out, for example by photocorrelation spectroscopy (PCS), to determine whether particles form which are the oxides of the metal or boron compound, for example TiO₂ particles. If such particles form, the addition has been effected too early or too late. The suitable time span for the addition, in which these particles are not formed, can easily be determined in this manner.

Another method for determining the time of addition, which can be carried out easily, is the determination of the clearpoint. On addition of water to the hydrolysable silicon compound or compounds, an aqueous phase and an organic phase result. This is indicated by turbidity of the stirred reaction mixture. At the clearpoint, these two phases become homogeneous and the reaction mixture clears. Even if the reaction mixture remains turbid, for example owing to polysiloxanes present, this clearpoint is detectable. Since the clearpoint occurs as a rule approximately when the added water has been substantially consumed or the water content is minimal, the metal or boron compound can be added when the clearpoint has been reached. This of course includes addition shortly before or after the clearpoint.

The binder obtained can be used as it is. The resulting sol can be adjusted to the viscosity desired for the binder by suitable parameters, for example degree of condensation, solvent or pH. In a preferred embodiment, the binder is allowed to mature or age by simply allowing to stand, for example for at least 1 h and preferably at least 5 h. Thereafter, it can be used for the intended application.

It was also surprisingly found that an even more homogeneous heterocondensate can be obtained if the starting materials are used undiluted, i.e. without a solvent. The hydrolysis and condensation which are effected after addition of water and the subsequent addition of the boron or metal compound are therefore preferably carried out without addition of solvent. It should be taken into account that solvents may form in situ during the hydrolysis reactions of the starting materials, such as the alcoholates. The reaction mixture is as a rule therefore not solvent-free during the progress of the hydrolysis but substantially less dilute than is otherwise customary according to the prior art. After completion of the reaction, for example after the above maturing, solvent can be added, for example for adjusting the viscosity.

The intended amount of water can be added completely in step A). In an embodiment, a part of the intended amount can be added only after the addition of the metal or boron compound. In this case, instead of using 100% of the intended amount of water as described above in step A) for the hydrolysis, for example, 90 to 20% and preferably 70 to 30% of the intended amount of water as described above can be used. The remainder of the intended amount is then added, for example, directly after the addition of the hydrolysable metal or boron compound or preferably after maturing. In another embodiment, 100% of the intended amount of water as described above are used in step A) for the hydrolysis and an additional amount of water can be added after the addition of the metal or boron compound. Expedient amounts for the additional water then correspond to the abovementioned amounts for step A). It is also possible to add more water, especially after maturing is complete.

The optional and preferably used organic binder component described is, as stated, preferably added after preparation of the heterocondensate, but it can also be added beforehand. In this case, the binder component is added to a precursor of the heterocondensate, i.e. for example to the hydrolysable or the hydrolysed silicon compounds or to the metal or boron compound. The polysiloxane component is preferably initially introduced together with the other Si components before the water is added. It can optionally also be added at a later time. The additional metal compounds described above are preferably added together with the metal or boron compound of the formula (III).

The components described are, as explained above, preferably used as such but can optionally also be diluted in each case with a solvent. Solvents may also be added after the preparation of the binder, for example for adjusting the viscosity. It is also possible, if appropriate, to use additional water for this purpose, but preferably only after maturing.

If required, customary additives may also be added to the binder prepared. Thermal or photolytic catalysts for the polymerization are preferably also added to the binder, preferably thermal initiators. These may be, for example, ionic initiators or free radical initiators. The catalyst initiates the polymerization, with the result that the binder is cured or crosslinked. These catalysts are known to the person skilled in the art and he can readily choose the suitable ones while taking into account the components used. Examples of free radical thermal initiators are organic peroxides, e.g. diacyl peroxides, peroxydicarbonates, alkyl peresters, alkyl peroxides, perketals, ketone peroxides and alkyl hydroperoxides, and azo compounds. Specific examples are dibenzoyl peroxide, Trigonox® 121, tert-butyl perbenzoate, amyl peroxy-2-ethylhexanoate and azobisisobutyronitrile. An example of an ionic initiator which is suitable for the thermal initiation is 1-methylimidazole. These initiators are used in the customary amounts known to the person skilled in the art, for example 0.01 to 5% by weight, based on the total solids content of the binder.

Examples of further solvents which can be used are alcohols, preferably lower aliphatic alcohols (C₁-C₈-alcohols), ketones, ethers, monoethers of diols, such as ethylene glycol or propylene glycol, with C₁-C₄-alcohols, amides, tetrahydrofuran, dioxane, sulphoxides, sulphones or butylglycol and mixtures thereof. Alcohols are preferably used. It is also possible to use high-boiling solvents. In some cases, other solvents are also used, e.g. light paraffins.

Other conventional additives are, for example, dyes, pigments, viscosity regulators and surfactants. For the preparation of emulsions of the binder, for example, the stabilizing emulsifiers customary in the case of silicone emulsions, such as, for example, Tween® 80 and Brij® 30, can be used.

The resulting binder according to the invention is usually present in particle-free form as a solution or emulsion and in particular is free of crystalline products or particles. In particular, it is a binder sol. By photocorrelation spectroscopy (PCS), it was possible to show that the binders according to the invention contain substantially no particles. This shows that a homogeneous heterocondensate is formed and not isolated TiO₂ particles.

According to the invention, a binder which comprises a heterocondensate which is a metallosiloxane or borosiloxane and contains heteroatom units of heteroatoms selected from B, Al, Ga, In, Ti, Ge, Sn, Pb, Ti, Zr, Hf, Sc, Y and La, which are incorporated into the siloxane skeleton via oxygen bridges, and siloxane units, in which the silicon atom has a nonhydrolysable organic radical, is accordingly provided, the organic radical comprising no polymerizable groups. Depending on valency, the heteroatom is incorporated into the siloxane skeleton via 2, 3 or 4 oxygen bridges. B, Al, Sn, Ti and Zr are preferably used as heteroatoms, so that boro-, alumino-, stanno-, titano- or zirconosiloxanes are formed, titanosiloxanes being particularly preferred.

At least some of the Si atoms or all Si atoms of the siloxane skeleton have the nonhydrolysable organic group. If Si components according to the formula (II) were additionally used, the heterocondensate also comprises corresponding siloxane units.

The formation of the heterocondensate can be schematically illustrated as follows without taking into account ratios or distribution, the radicals R representing the nonhydrolysable organic group and X representing the hydrolysable group as defined in the above formulae:

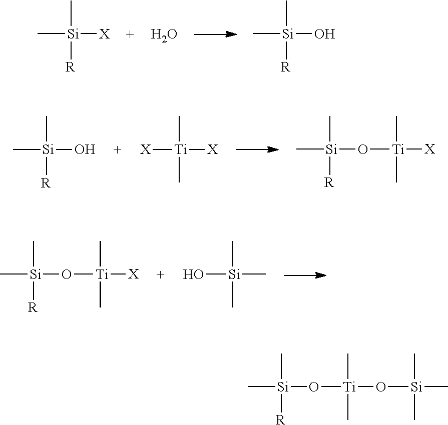

The undefined valencies in the scheme can denote substituents according to the above formulae, OH groups or oxygen bridges. Very homogeneous heterocondensates in which the heteroatoms are homogeneously distributed in the condensate, i.e. in molecular disperse form, can advantageously be formed by the process according to the invention. In contrast, in the case of joint hydrolysis, the heteroatoms condense substantially with one another so that, for example in the case of Ti, substantially TiO₂ particles are formed alongside a siloxane condensate, and homogeneous heterocondensates are not obtained.

A further important advantage of the binders obtained is that they are present as sol or solution even after a relatively long time and do not form a gel. Thus, the binders gelled only after days. The stability of the binder sols is important since gelled binders can no longer be used because mixing with the respective material is no longer possible. According to the invention, stable and hence storable binders are obtained.

Oil-, hot water- and heat-resistant binders are obtained. They are suitable for producing moldings and for consolidating loose or porous substrates, in particular finely divided, pulverulent or particulate substrates, in particular inorganic granules, the binder being mixed with the substrate, for example in the form of particles, granules or fibres, optionally brought into the desired shape and then hardened. The substrate to be set may be selected, for example, from metals, nonmetals, glass, ceramic, carbon, oxides, nitrides, carbides, borides, minerals, plastics, plastic fibres, glass fibres, mineral fibres, natural fibres, sand, soil, gravel, concretes, cements and wood-base materials. The substrate may be, for example, a geological formation, particles, or a bed, soil or rock.

The binder according to the invention is used for consolidating the substrate, for example the inorganic granules, such as, for example, sand. For this purpose, for example, a bed of the substrate is mixed with the binder and then hardened. The mixing can be effected in the customary manner, for example by admixing or infiltrating the binder into the substrate to be consolidated, for example by pumping in.

The hardening of the binder or of the molding is preferably carried out thermally by supplying heat. Examples of catalysts or initiators suitable for this purpose were mentioned above. Another method of hardening is to supply condensation catalysts which result in further crosslinking of the inorganically crosslinkable SiOH groups or metal-OH groups with formation of an inorganic network. Condensation catalysts suitable for this purpose are, for example, bases, but also fluoride ions.

The properties of substrates bound using a binder also depend on the conditions under which they are hardened. The hardening is also referred to as setting. As a rule, improved behaviour is obtained if the setting process is effected under approximately the same conditions as those under which the set substrates are to be used or are present. For applications at elevated pressures and temperatures, it is therefore desirable also to carry out the preparation under approximately the same conditions.

Thus, for example at relatively great water depths, hydrothermal conditions are present, i.e. at elevated temperature and elevated pressure so that, for applications at such water depths, it is expedient to carry out the setting also under the corresponding hydrothermal conditions, e.g. at temperatures above 40° C. and at least 4 bar, or directly at the place of use. A particular advantage of the binder according to the invention is that it can be cured or set even under such hydrothermal conditions, so that it is particularly suitable for applications under these conditions, for example under water.

The setting (hardening) for such applications is preferably effected at elevated temperature and elevated pressure, based on normal conditions, i.e. the pressure is greater than 1 bar and the temperature is higher than 20° C. Preferably, the binder is hardened according to the general geological conditions of the reservoir in which it is used, as a rule at temperatures above 40° C. and pressures of at least 40 bar. By using the organic component, improved mechanical strength and good flexibility are also achieved by formation of the IPN polymer after setting.

Depending on the chemical properties of the organic and inorganic constituents, the binder according to the invention can be hardened via a purely inorganic condensation mechanism or via additional polymerization reactions (parallel to the condensation, before the condensation or after the condensation). Organic components capable of polymerization, polyaddition or polycondensation can be used for this purpose. Depending on the shrinkage behaviour established, sealing or merely consolidation of a bed or of particles can be effected.

The behaviour of the binder according to the invention can be controlled so that voids or channels as occur, for example, in formations, particulate materials and beds are completely filled or remain completely or partly open. The consolidation of the bound substrate can thus lead to a seal on filling of the voids or channels or, in the absence of filling, to at least partial retention of the permeability of the unbound substrate.

If the binder consists, for example, mainly or exclusively of the inorganic component, the permeability of the substrate can be maintained owing to the syneresis effect described above, since the substrate remains porous. On the other hand, the organic binder component tends to lead to filling of the pores or channels and hence to a seal. Depending on the ratio of inorganic component to organic component used in the binder, consolidation and sealing or consolidation and at least partial retention of the permeability can be achieved. Since polymerization of the organic binder component leads to shrinkage during the polymerization, an organic binder component comprising unreactive oligomers or polymers is preferably used if, for example, complete sealing of the substrate is desired.

Since, particularly under hydrothermal conditions, setting of materials with the binder according to the invention can partly or completely prevent a compaction process, the binder can close pores with a large volume. This can be prevented or eliminated, for example, preferably by displacing the liquid binder from the pores, for example by blowing a liquid or gaseous medium, such as air or nitrogen, into the material which is to be set and which has been mixed with the binder, so that binder remains only at the contact points of the particles, with the result that porosity can be established in the desired manner. The blowing in is effected in particular before or during the setting over a certain period.

Parameters for pumping through, such as duration, time, amount or flow rate of the liquid or gaseous phase, can be readily chosen by the person skilled in the art in a suitable manner in order to establish the desired porosity. The introduction can be effected, for example, before or after partial hardening, complete hardening taking place after and/or during the introduction. For introducing a liquid or gaseous medium, for example, an inert solvent or gas, e.g. N₂, CO₂ or air, can be pumped in, with the result that the pore volumes are flushed clear and reaction products are removed. The liquid or gaseous medium can optionally contain catalysts and/or gas-releasing components or dissolved substances.

The binder according to the invention can therefore be used for the formation of moldings or for the consolidation of formations. In particular, the binder can be used for the consolidation of geological formations or of beds of granules, in particular in the oil and gas extraction sector. The binder is also suitable for consolidating foundry sands. Further fields of use for the binder are the consolidation of friable sandstones in architecture or the production of brake linings.

Owing to its chemical constitution as explained above, the binder according to the invention permits rapid and effective consolidation of oil- or water-carrying, generally sand-containing geological formations. Furthermore, it was found that the binders are also particularly suitable for contaminated sands, in particular oil-polluted sands, since the binder can migrate under dirt, in particular an oil layer on the inorganic surface, and detach it. The latter has the additional effect that such systems are also suitable for detaching fats and oils from inorganic surfaces and, for example, improving the discharge of such substances from the interstices of sand beds or geological formations. It is therefore possible to realize binding processes in oil-containing sands and clean such sands by removing oil. A treatment of contaminated sand with the binder can therefore perform a consolidating or a cleaning function or can fulfil both purposes.

For this purpose, the heterocondensate may additionally contain a component which is oleophobic and hydrophobic, with the result that the wetting behaviour of geological formations can be changed. Preferably, one or more silanes of the general formula (V)

Rf(R)_{b}SiX_{(3-b)} (V)

in which X and R are defined as in formula (I), Rf is a nonhydrolysable group which has 1 to 30 fluorine atoms bonded to aliphatic carbon atoms, and b is 0, 1 or 2, are used for the oleophobic and hydrophobic component of the heterocondensate as an additional Si component for the preparation of the heterocondensate. These compounds are also referred to below as fluorosilanes. The silane can be used in the process according to the invention as an additional Si component in exactly the same way as described above for the other optional Si components.

In the formula (V), Rf is preferably a fluorinated alkyl group, for example having 3 to 20 C atoms, and examples are CF₃CH₂CH₂, C₂F₅CH₂CH₂, n-C₆F₁₃CH₂CH₂, i-C₃F₇OCH₂CH₂CH₂, n-C₈F₁₇CH₂CH₂ and n-C₁₀F₂₁—CH₂CH₂. Preferred examples of Rf are 1H,1H,2H,2H-perfluorooctyl. Examples of fluorosilanes which may be used are CF₃CH₂CH₂SiCl₂(CH₃), CF₃CH₂CH₂SiCl(CH₃)₂, CF₃CH₂CH₂Si(CH₃)(OCH₃)₂, C₂F₅—CH₂CH₂—SiZ₃, n-C₆F₁₃—CH₂CH₂—SiZ₃, n-C₈F₁₇—CH₂CH₂—SiZ₃, n-C₁₀F₂₁—CH₂CH₂—SiZ₃, where Z═OCH₃, OC₂H₅ or Cl; i-C₃F₇O—CH₂CH₂CH₂—SiCl₂(CH₃), n-C₆F₁₃—CH₂CH₂—Si(OCH₂CH₃)₂, n-C₆F₁₃—CH₂CH₂—SiCl₂(CH₃) and n-C₆F₁₃—CH₂CH₂—SiCl(CH₃)₂.

The binder may result in a change in the wetting behaviour of sands so that it tends to serve as a composition which regulates the wetting. It may be expedient for this purpose to use the binder in high dilution, for example having a solids content of not more than 10% by weight.

There follow examples for explaining the invention, but which are not intended to limit it in any way.

### EXAMPLE

### Synthetic Binders

### 13.2 g of MTEOS

### 1.8 g of 1M HCl

4.8 g of titanium isopropoxide (TPT)
3.6 g of 2-(methacryloyloxy)ethyl acetoacetate (MEAA)
22.9 g of diethylene glycol dimethacrylate (DEGMA)
0.5 g of butyl acrylate (BA)
MEAA was added to TPT at RT and stirred for 30 min. MTEOS was hydrolysed with 1M HCl. After the clearpoint, the solution of MEAA and TPT was added. Stirring was effected for 1 h at RT and then DEGMA and BA were added. The hardening was effected with 2% by weight of Trigonox 121 at 60° C. for 12 h.

### Production of Syringe Samples

10 ml syringes were filled with sand (30/40 mesh) up to 6 ml. Instead of sand, it is also possible to treat soil, gravel, concretes or cements in the same way. Thereafter, the binder (with 2% by weight of Trigonox® 121) was drawn up. Any air present was removed and the syringe ends were sealed. Weighing the syringes in random tests showed that the amount of binder is virtually constant under these conditions. The samples were hardened in an autoclave (nitrogen, 200 psi) for 14 hours at 60° C. After 14 h, the autoclave was cooled, the samples were removed and their compressive strength was determined. The measured compressive strength depends on whether the samples are measured directly after removal from the autoclave in the moist state or whether the samples are dried before the compressive strength test. The “gelling time” (see below) was about 30 min. Viscosity of the binder at RT: about 3 cP, solids content (theoretical): 71.1%. Furthermore, the uniaxial compressive strength (UCS strength) was determined.

UCS strength after hardening (moist sample): 10.2 MPa
UCS strength after drying of a sample in the air (RT, 4 d): 11.6 MPa
UCS strength after 65 h in 3% by weight KCl solution (90° C., 500 psi): 7.5 MPa

### “Gelling Time” Test

For determining the time until the polymerization starts, the viscosity of the binder is measured in a rheometer (at 150 psi) with increasing temperature. From a certain point, the viscosity increases rapidly. This is assessed as the start of the polymerization.

1.-31. (canceled)

32. A process for the preparation of a binder which comprises a heterocondensate of (i) at least one hydrolysable silicon compound having at least one nonhydrolysable organic radical, and (ii) at least one of a metal compound and a boron compound, wherein the process comprises:
(a) mixing and hydrolyzing (i) with water to form a reaction mixture;
(b) adding (ii) to the reaction mixture of (a) after the water in the reaction mixture of (a) is substantially consumed to form the heterocondensate;
(c) optionally, adding an organic binder component to at least one of the heterocondensate and a precursor thereof;
the at least one nonhydrolysable organic radical of (i) not comprising a polymerizable group and the metal of the metal compound (II) comprising at least one of Al, Ga, In, Tl, Ge, Sn, Pb, Ti, Zr, Hf, Sc, Y, and La.

33. The process of claim 32, wherein in (b) at least one of a metal compound and a boron compound that comprises a complex ligand having a polymerizable group, or a combination of (ii) and a complex ligand having a polymerizable group is added to the reaction mixture of (a).

34. The process of claim 32, wherein the at least one nonhydrolysable organic radical of the hydrolysable silicon compound comprises alkyl or aryl.

35. The process of claim 32, wherein (i) and (ii) are employed in the absence of a solvent.

36. The process of claim 32, wherein the water employed in (a) contains a catalyst.

37. The process of claim 32, wherein following the addition of (ii) additional water is added.

38. The process of claim 32, wherein in (a) at least one hydrolysable silane without nonhydrolysable groups is hydrolyzed together with (i).

39. The process of claim 32, further comprising adding at least one polysiloxane having at least one reactive group.

40. The process of claim 32, wherein the organic binder component comprises at least one of an organic monomer, an organic oligomer, and an organic polymer comprising at least one polymerizable group.

41. The process of claim 32, wherein the organic binder component comprises at least one of an unreactive organic oligomer and an unreactive organic polymer.

42. The process of claim 32, wherein the metal of the metal compound comprises at least one of Al, Sn, Ti, and Zr.

43. The process of claim 32, wherein the metal of the metal compound comprises at least Ti.

44. The process of claim 32, wherein (ii) comprises an alkoxide of at least one of Ti, Zr, and Al.

45. The process of claim 32, wherein a molar ratio of Si atoms to metal and/or boron atoms is from 10:1 to 1:3.

46. The process of claim 32, further comprising adding at least one of a solvent and a polymerization catalyst.

47. A binder which is obtainable by the process of claim 32.

48. A binder comprising a heterocondensate, wherein the heterocondensate comprises at least one of a metallosiloxane and a borosiloxane that contains (i) heteroatom units comprising one or more heteroatoms selected from B, Al, Ga, In, Tl, Ge, Sn, Pb, Ti, Zr, Hf, Sc, Y, and La, which heteroatom units are incorporated into a siloxane skeleton by oxygen bridges, and (ii) siloxane units in which a silicon atom has bonded thereto at least one nonhydrolysable organic radical that does not comprise a polymerizable group.

49. The binder of claim 48, wherein the binder comprises a binder sol.

50. The binder of claim 48, wherein the binder is particle-free.

51. The binder of claim 48, wherein the binder further comprises at least one of an organic monomer, an organic oligomer, and an organic polymer as an organic component, so that, upon hardening, an inorganic-organic component is formed as an interpenetrating polymeric network.

52. The binder of claim 51, wherein a weight ratio of heterocondensate and organic component, based on hardened binder, is from 95:5 to 5:95.

53. The binder of claim 48, wherein the one or more heteroatoms comprise at least one of B, Al, Sn, Ti and Zr.

54. The binder of claim 48, wherein the metallosiloxane comprises a titanosiloxane.

55. A method of consolidating a porous or loose substrate, wherein the method comprises contacting the substrate with the binder of claim 48.

56. The method of claim 55, wherein the substrate comprises a geological formation.

57. The method of claim 56, wherein the geological formation comprises at least one of a particulate material, a bed, soil, and rock.

58. The method of claim 56, wherein the consolidation comprises sealing the substrate to completely or substantially completely fill voids in the substrate with the binder after hardening.

59. The method of claim 56, wherein upon consolidation voids in the substrate remain completely or partly open to at least partly maintain in the consolidated substrate a permeability of the unbound substrate.

60. The method of claim 55, wherein the binder is at least one of mixed with and infiltrated into the substrate, followed by thermal hardening of the binder.

61. A method of treating contaminated sand, wherein the method comprises contacting the contaminated sand with the binder of claim 48.

62. A molding, wherein the molding comprises a finely divided, pulverulent or particulate substrate which is bound with a hardened binder of claim 48.

63. The molding of claim 62, wherein the molding is porous.

64. A molding, wherein the molding comprises a finely divided, pulverulent or particulate substrate which is bound with a hardened binder of claim 51.
